(19) United States
(12) Patent Application Publication
(10) Pub. No.: US 2004/0025189 A1
(43) Pub. Date: Feb. 5, 2004

(54) Convergent box set

(76) Inventors: Petra Bauersachs, Ochtandung (DE); Guido Ciburski, Ochtendung (DE)

Correspondence Address: Robert W Becker & Associates, Suite B, 707 Highway 66 East, Tijeras, NM, 87059, US

(21) Appl. No.: 10/432,805

(22) PCT Filed: Nov. 9, 2001
(86) PCT No.: PCT/EP01/12960

(30) Foreign Application Priority Data
Nov. 23, 2000 (DE) 100 58 347.4

(51) Int. Cl. H04N 7/173

(52) U.S. Cl. 725/133; 348/552

(57) ABSTRACT

The invention relates to a convergent box set consisting of a standard audio-video transmission cable and an electronic switch and control device which is arranged on both ends of the cable. The invention enables modern television and multimedia applications to be carried out on a commercial television set in a cost-effective manner without using expensive set-top boxes. Said applications include internet access on the television, secure home banking using the television and the remote control, digital storage of audio clips and television programmes, personal programming of the television and video recorder, remote control of the television and video from the internet, playing DVDs, video CDs and audio CDs on the television.

The invention refers to a convergence boxes set for personal computers.

The objective of all modern supplementary appliances for televisions, such as set top boxes, Web TV boxes, along with the basic function of program decoding, is to extend the limited TV functionality: the objectives are

Gaining time through the parallelizing of applications (entertainment in the foreground, downloading in the background)

Comfort (reading an incoming fax or an incoming mail on the TV without having to get up)

Acquiring content or multiple utilization through quick recording; recording files to the hard disk; recording music as MP3 or by burning music CDs

In detail, a viewer is to be able to use the following modern functions in front of a TV set that is located in its usual place, in the living room.

1. Internet Access through the TV:

1.1 Secure Home Banking through TV and Remote Control

All four types of home banking are to be supported:

through Internet access (per HBCI or PIN/TAN)

through Internet Service Provider Legitimation (T-Online)

through KEY diskette (HBCI)

through chip card

1.2 Other Authentication Procedures

Digital signatures, the connection of fingerprint detectors or iris detectors and the use of the appropriate software are also to be possible at the TV set.

1.3 Display of all Internet Formats

While Web TV boxes, depending on the development status, are only able to display a subset of all formats (the first Web TV boxes were unable even to display frames) the solution that is aimed for is to be able to display all formats and carry out all Internet functions, for example:

Reading out/saving cookies

Secure HTML

DHTML pages

JAVA per JVM Java Virtual Machine e.g. for homebanking applications and for taking part in audio chats (using a microphone)

JavaScript

ftp; htp; http; mms; etc.:

Display of audio and video formats (RealAudio; QuickTime AVI; multimedia streams; streaming video; MPEG2; MPEG4, etc.)

For the correct replay of defined formats it must be possible to download and install various supplementary software, e.g. as plug-ins for the Internet browser.

1.4 Requesting Content Such as Video-On-Demand or Software

Requesting (and paying for) the required content from the Internet; optional transport from the Internet per sterling (authenticity) or download (time-delayed) or per satellite.

1.5 Full E-Mail Functionality with Central Contact and File Management

The following restrictions are disadvantageous for the e-mail functionality of known STBs or Web TV boxes:

e-mail addresses cannot be saved or reused.

News attachments are lost because there is no storage space, or cannot be opened because there is no read software (Word, Acrobat Reader, Excel, Video Player, Audio Player).

News (mails and news) cannot be easily reused on the home PC.

The aim of the solution that is introduced here is to get around these disadvantages.

2. Extended TV and Video Recording Functions

2.1 Personal TV

The aim of the system is to enable differentiated and individual media use. This is traditionally not possible with a push technology, such as television, because the user can only see what is being offered at the moment. The use of time delays (recording and playing back later on) is one possibility, see below. But even in real time, users can navigate using their own personal preferences. The user enters his favorite subjects, titles, performers, directors or key words and the system uses these parameters to determine a sequence within which the user can change channels. He can chose whether undesired subjects are to be masked out, or only filed with a very high program position number. Desired subjects can be filed dynamically with low program numbers, or the TV switches on automatically for desired subjects. The basis of this technology is an EPG (Electronic Program Guide) that obtains its basic program data from a central position, e.g. via the Internet.

By means of a real time channel program features that are not set beforehand can also be transmitted and the television set can react automatically to this when selecting programs: e.g. commercial block signals (switching channels, switching back at the end of the commercials, stopping the video recorder); parental control signals (masking out sex and/or violence if children are viewing).

2.2 Personal video

In the same way as above programming the TV video recording using various feature criteria (subjects, key words, performers, etc., but also formats; date made, broad band, etc.) is to be made possible.

2.3 Instant replay

Where a hard disk is used as the recording medium permanent recording of the last ten minutes is to be possible, as far as real time encoders are used. This is to enable rewinding at any time within a program.

2.4 Optional Analogue or Digital Storage of Audio Clips and Television Programs

It is to be possible to save current programs digitally or analogously with the remote control. It is to be possible at any time to convert from video format to digital (e.g. for processing) and back. In addition, it is to be possible to burn films or audio recordings on CD.

3. Controlling the Home Entertainment Appliances

The system is to be able to control, among other things, TV sets, video recorders, satellite receivers, digital receivers and hi-fi systems (on; off; changing channels; quieter, louder, sound off/on; etc.). The intention is to achieve an overall harmony of the interfaces without new appliances with networking interfaces such as FireWire being required. For example, the hi-fi system is to be switched to mute if a telephone call is received.

4. Interfacing the Home Telephone System to the Television Set and Telephony Function on the TV

Telephone calls are to be accepted directly at the TV via remote control (display of the caller number, properties/picture of the caller; last call; input of key words on the current call; save to resubmission if call-back required).

4.1 Video Telephony Receiver and Transmitter:

It should be possible to display callers on the home TV screen with their pictures. It should also be possible to transmit the user's own picture to the conversation partner via a webcam. It should be possible to use existing Internet chat/net-meeting software packages for this purpose.

5. Remote Control of TV and Video, for Example, from the Internet

All appliances connected to the system are to be controllable via the Internet, either by requesting direct control commands or by updating control files via Internet log-on into the system or control files stored in the Internet being updated in the Internet and the control instructions being requested and processed on the next system dial-in to the Internet.

6. Using DVDs and Video CDs and Audio CDs with the TV

It should be possible to use an existing DVD player, CD player or CD burner in the home at the PC or TV independently of where the user has installed it and without it being necessary to acquire new appliances.

7. Remote Use of Existing Hardware at the TV, Even where this is Installed on the PC

It should be possible to save or print a text viewed on the TV to hard disk or floppy via remote control without having to acquire an additional printer or installing it in the living room.

8. Using PC Games or Internet Games on the TV

On the one hand, it should be possible to play games directly on the TV without having to install a PC in the living room; on the other hand, a player at the TV set should be able to play against or with other players at the PC.

9. Central Help Provision with Personal Installation and Updates of Supplementary Software

The user should be able to acquire software updates automatically by dialing into the Internet, and also the program configuration (e.g. the input of the telephone number in a chat program is to be carried out before the download to identify the user unambiguously).

10. Using a PC in the TV

It is intended for the user to be able to operate the programs that are familiar from the PC environment from the living room and to access his PC's data or the data in his Internet storage area. This PC work is to run parallel to TV viewing. It should be possible to observe long PC processing jobs parallel to the TV program. The switchover between TV viewing and the parallel sequence on a monitor is to be supported by windows technology. Where possible, the TV screen is to display more than just one program, but several programs parallel. It is also intended that that standard I/O instruments (keyboard, mouse) can be used from the living room.

11. Full PC Functionality

It is intended that external PC appliances, such as CD burners, DVD drivers, CD players, TV cards, scanners, fax cards, modems and printers, can be used from the armchair without the acquisition of additional hardware.

12. Voice Controls Parallel to Menu Navigation

The users is to have the opportunity to use the facilities familiar from the PC for voice controls through voice recognition software for TV navigation as well, or for navigation at the TV. Standard voice software is to be used for this purpose, i.e. without any adaptation to the hardware of a set top box.

13. Reading Incoming Messages or Existing Text

It is intended that text, mails or menu prompts can be outputted on the audio output of the TV set. Standard voice software is to be used for this purpose, i.e. without any adaptation to the hardware of a set top box.

14. Interactive Television

Parallel to and matching the TV program currently being viewed by the user additional information is either to be inserted without request, or the user is to be able to request additional menus via the remote control. Animated images are to be inserted within the TV image that are either linked to Internet pages or request additional programs. The control data for these services are to be transmitted previously to the system or live, e.g. via an Internet connection.

15. Personal Information Center

Information coordinated to the personal structure is to be displayed each morning on the TV screen. At the push of a button, the user is to be able to print and file his own morning newspaper. The information is, for example, requested from the Internet before the user gets up. If particularly relevant information is found (e.g. a stock limit is reached) the TV should be switched on immediately. Additional state-of-the-art data flows, such as teletext or Intercast services on the part of the TV station, which are also searched for key words, are to be integrated as data sources.

16. Internet TV Transmission Sources Bouquets

The user is to be able to select the program sources independently of the technical storage locations or delivery paths. He is to be able to receive films from cable TV or via satellite through the usual broadcasting paths, or also to be able to play them back from Internet video sequences.

This also applies to the integration of DVDs, video recorders or video CDs.

Up to now, additional and powerful hardware has been required for all this:

First of all, the set top boxes (STB) have to be fitted with modems to be able to exchange data with the Internet. Technically. two domestic terminal procedures have to be supported (ISDN—analogue telephone).

A very long telephone cable has to be included in the delivery items, because there is not always a telephone port near the family TV.

There has to be sufficient permanent memory to manage all the accruing data (e-mail addresses, Internet bookmarks, telephone and fax numbers, user preferences in regard of favorite TV subjects and titles).

Very large hard disk capacities must be available for storing and playing video films. If less hard disk memory is to be sufficient, real-time compression is necessary. This itself requires the most powerful processors and sufficient main memory.

Processors in the Pentium class from 300 MHz and large main memories (up to 32 MB, 8 MB Flash) are also necessary, in order to be able to carry out real-time compression, program decoding (Pay-TV decoder) together with the parallel tasks user guide, EPG, scheduler, etc.

Because of the rapid technical developments, this hardware is obsolete within one year and usually cannot be upgraded.

Web TV boxes, such as, for example, the WebTV (R) Box from Philips or Sony are known. These appliance types have the disadvantages that not all Internet formats can be displayed in the usual manner, because either Java is not available or there is insufficient buffer memory space for video and audio streams. It is also not possible to store Internet pages. Printouts are not possible either, or only with the additional installation of a printer in the living room, which users generally do not want. Digital film storage is not available because there is no hard disk, neither is the local reuse of existing e-mail addresses or bookmarks possible. The export of data acquired during surfing is difficult to carry out, because there are no exchange media. There is no interaction with the television program because there are no control facilities. The necessary telephone outlet is not found in all living rooms but often only in studies. The user has to familiarize himself with a completely new navigation system. Interactive television is only possible to a limited extent because of a lack of feedback via the program that is currently being viewed. Only proprietary operating systems run in the operating systems of the Web TV boxes. The user cannot add additional software and for this reason software is not offered.

Digital set top boxes such, as, for example, the dBox from the company betaResearch, are also known. Only proprietary operating systems run in the operating systems. The user is unable to add new software directly and for this reason the range of software is limited. Even if open standards are used, software updates are only possible on a change of program and must then be deleted from the main memory. The use of additional software by the user is therefore difficult and extremely limited. The same disadvantages that were described above for the Web TV boxes apply in regard of Internet display capability, PC interoperability and navigation.

Special set top boxes such as the CrossTV box from the company Infomatec AG or the i-box from the company TCU AG are designed for a particular sub-task (in the example: interactive television, or blocking commercials and EPG). It is impossible for users to use additional software. The same disadvantages that were described above for the Web TV boxes apply in regard of Internet display capability, PC interoperability and navigation.

Finally, digital video recorders were introduced recently that enable storage to hard disk (at high hardware prices), but they are unable to conform to the further requirements that were described above.

The task of the invention is to construct low-cost and simple hardware with which a universal solution as described above is achieved. A hardware structure existing in the household is integrated here to avoid double purchases. Additional required hardware are to integrate industrial standards and therefore enable a widely available selection of appliances. Proprietary hardware components are to be reduced to a minimum to make the rapid development in the respective sectors usable for the user.

In accordance with the invention, the problem is solved through the elements of Patent claim 1. Additional advantageous embodiments of the invention result from the subclaims.

In this way, a solution is arrived at that achieves maximum benefit with minimum costs per household. The software used is compatible to the industry standard, can be exchanged in modules and is retrofittable. PC data are reused seamlessly and are not available double, to avoid redundancy errors. PC skills are still reusable and there is no requirement for familiarization with new navigation systems. TV viewing functions with PC support, in that the PC always knows the currently viewed program and offers better programs after a comparison with the user's preferences and the EPG, masks out undesirable scenes or programs, carries out video recording in the background or realizes the TV broadcast to the Internet, or offers the user interactive services.

The user can keep his usual menu guide and navigation at the television and equip his system as required with additional standard software. The possible linking of standard software enables a broad and rapid new development of improved solutions to take effect here as well.

The following components are presupposed as being state-of the-art for the system for the domestic sector introduced here:

A PC, or the possibility of installing a PC in another room. The usual programs are installed on this PC (e-mail, Internet, word processing, multimedia player). In addition, the standard hardware is installed (printer, monitor, input devices such as keyboard and mouse). Even if a PC has not yet been installed, the solution introduced here has a monetary advantage in comparison with proprietary set top boxes. In most cases, the set top boxes that are on offer are more expensive than a standard PC, because the hardware components are comparable, but are manufactured in smaller volumes. In addition, the set-top box cannot be used for anything else, in contrast to a PC. The existence of a PC is presumed below.

A so-called PC base box is installed at this PC. This box, which is as big as a cigarette pack, contains only a few cheap hardware items and a terminal for a standard SCART cable, a SCART jack. A standard 21-pole, 50 m long SCART cable (a so-called convergence cable) can be connected here and is also low-priced because it is a standard mass-produced item. The so-called TV center box, which is also the same size as a cigarette pack, is at the end of this cable. This box must be in the user's line of vision and must be placed next to or on top of the TV set. Standard SCART extension cables can also be used for short distances, because the cable terminal at the center box is designed as a connector. A driver/software package containing the software for various operating systems is supplied as the fourth component of the system. Finally, a remote control similar to those with other set top boxes is also part of the scope of delivery for the solution presented here.

With a variety of domestic configurations, these five basic components already comply with the above requirements.

All other components are standard PC add-ons that, if not already present, could be acquired separately:

A TV card with the standard inputs and outputs (input: antenna cable, SAT cable, S-VHS; output: S-VHS or composite video) and the standard features: AVI recording, MPEG2 recording.

A wireless keyboard that transmits data via an infrared connection (webpad with PC terminal box).

A graphics card with a TV output (usually S-VHS or composite video) or if the user wishes to continue using his graphics card without a TV output, a VGA2PAL or VGA2NTSC converter, which is connected between the PC and the PC base box.

The modular breakdown means that the user only needs to acquire the components that he does not already have. This guarantees for each household the lowest cost solution for the requirements shown above. There is no double acquisition of hardware (within a household). The total system consists of standard components, which guarantees further technical developments and permanently low-cost performance.

The idea on which the invention is based is described in detail below by means of examples of embodiments that are shown in the drawings.

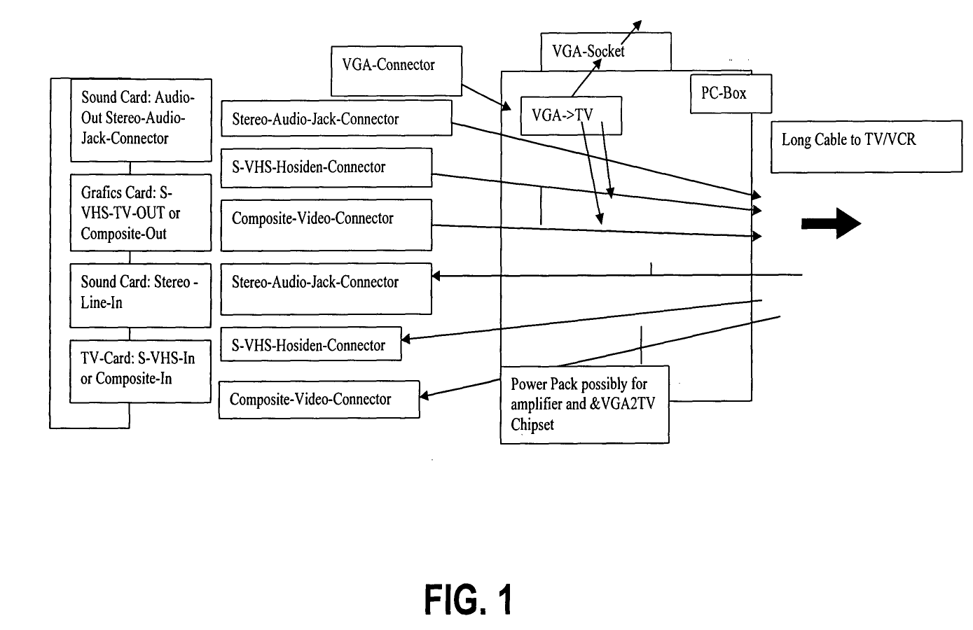

FIG. 1 shows a detailed representation of the AV signal guide by means of a PC base box,

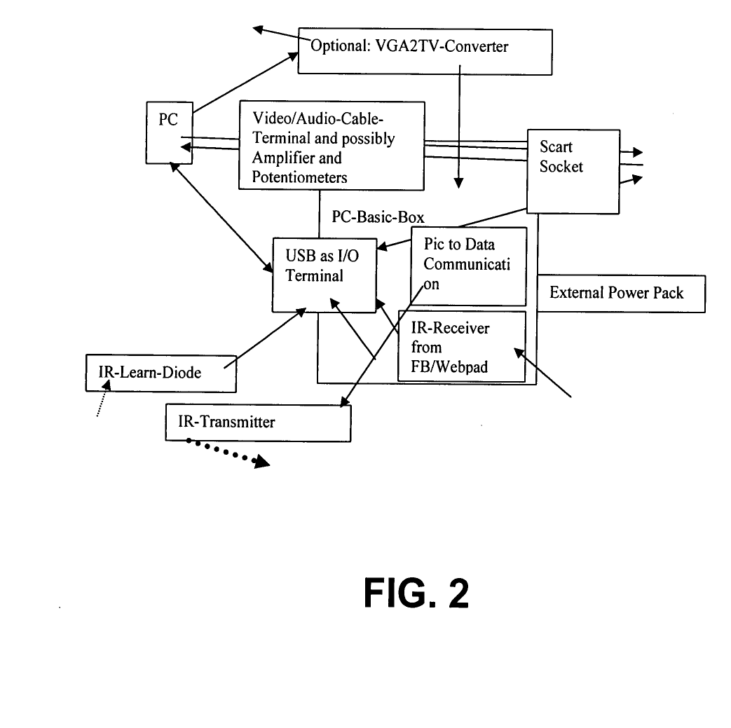

FIG. 2 shows a representation of the components contained in the PC base box and

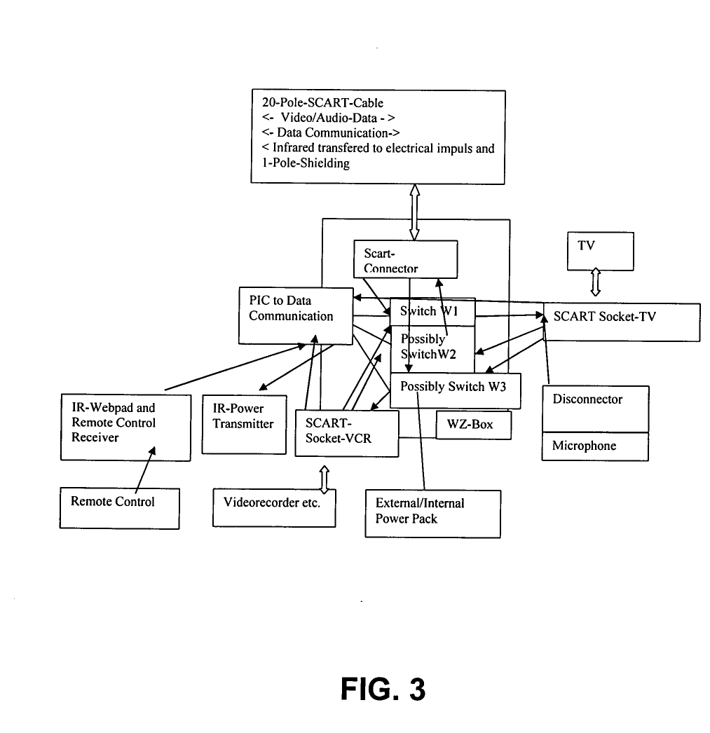

FIG. 3 shows a schematic representation of a TV center box.

As can be seen in FIG. 1, the PC base box enables the transmission of audio and video signals from the PC (or from other sources such as a satellite receiver, digital TV card, etc., DVD player) to the TV (or to other AV sinks such as video recorders, digital recorders, etc.) and back. As an option it is possible to insert a VGA→TV converter.

Particular mention should be given to the connection of the IR learning diode in FIG. 2. This diode can be used to store IR transmission signals with which the home entertainment appliances in the living room (TV, video, etc.) can be controlled.

A standard IR receiver diode is also found at the end of a cable in the base box. This enables the supplied remote control and a standard webpad can be used directly at the PC. Because webpads also receive data (control of the Num-Lock/Scroll lamps) and it may also be necessary to control receivers next to the PC, there are also IR transmitters on a cable of the PC box.

The solution can of course also be realized as a plug-in PC card instead of as an external box.

The PC box parts list consists in total of the following components:

PCD, housing and components

4 video connectors (2×S-VHS, 2×composite)

2 audio cables (stereo, cable, jack connector+doubler)

PIC controller for data communication (may be possible to do without this by having the PC driver take over tasks)

IR transmitter diodes, IR learn diode, IR receiver chip, set to remote control that converts the IR frequency into USB data. Or the remote control has the same IR code as the TV card remote control.

external power pack

data terminal: USB adapter cable, or Com2 cable or printer port cable

SCART socket

The PIC controller (PIC) shown in FIGS. 1 and 2 serves to encode and decode control signals. This means that several control cable commands can be transported on just two cores. All signals (audio, video, infrared converted to electr. impulses; data commands) can be transported via the 21-pole standard AV cable. Naturally, two cables of this type can be used, if this makes the overall solution more low-priced. Radio connections can also be used instead of cables. The maximum requirement for this is two high-frequency AV links and two low-frequency data links. Savings also result from the joint audio mass use.

The TV center box shown in FIG. 3 provides the connection for the TV and the existing TV periphery (video recorder, satellite receiver, etc.) by means of two SCART sockets. The convergence cable to the PC is connected at the SCART connector with unambiguous marking.

The counterpiece to the controller in the PC base box is also found here. In particular, control signals are transmitted through the PC and the periphery of the PC base box to the TV center box as I2C commands. These commands are converted here back into control cable commands. Example: command: “Is separating filter 1 on?”. This command supplies the status of separating filter 1 as the return value. This is why the controller is connected with all three switches (e.g. I2C).

The task of switches W1, W2 and W3 in accordance with FIG. 3 is the microprocessor-based switching of the audio-video input sources. The AV input of the TV can on the one hand obtain data from the PC or from the video recorder. The AV output to the PC can be supplied on the one hand from the TV output and on the other hand from the video recorder output. And, thirdly, the video recorder can record signals from the PC or from the television. The three separating filters solution provides a maximum of flexibility. To save costs, a single separating filter solution is also possible. (TV input can be switched between the video recorder output and the PC output, the TV output is permanently connected with the video recorder input and the PC input. The video recorder output is permanently connected to the PC input.) In spite of this, by means of clever routing the PC can make practically every function switchable. For example, the video recorder can output signals to the TV so that the TV viewer can control the digital recording. This signal is also applied at the TV output. From here, it goes to the PC input and can be recorded digitally.

A 12 Volt switching voltage generator can be switched on and off with microprocessor-based controls. Controlled by commands from the PC, it forces the switching over of a TV to the AV channel.

In total, the following components are necessary in the TV center box:

one to a maximum of three switches controllable via I2C

possibly a remote control (with the same IR code as standard TV cards)

IR output transmitter diodes

1 PIC controller for data communication

external power pack

2 SCART sockets, 1 SCART connector

IR receiver and amplifier

built-in microphone

microphone switch with On/Off switch, possibly LED; the switch is required to be able to add the microphone output on to the TV audio output, after the TV is switched to mute (in so far as mixed operations are not desired, for example audio dubbing with a video recorder)

12.5 Volt switching voltage generator

The fundamental disadvantages of set top boxes placed at the TV that were referred to are avoided by the layout and part components of the solution presented here.

The following advantages result, whereby completely new signal paths are opened up: PC→TV: (personal TV as the TV reception personalized through the PC; parental control filter; subject guide/play video films from the PC, Internet, etc., see above).

PC→VCR: e.g. for making teaching films or for saving digital PC clips to tape or playback of digital reprocessing.

VCR→PC: digital processing of analogue films.

TV→PC: through this signal path the PC can detect at any time the program that the TV is or was showing. It should therefore be possible to evaluate this signal path at any time.

TV→VCR: (standard recording of the current TV program on analogue tape).

VCR→TV: (standard playback of a video tape on TV).

In as far as all three possible switches are implemented, all signal paths can be combined at the same time with others.

Another example of an embodiment is described below:

The convergence boxes set is connected to the usual IO ports at a standard PC, preferably to the USB interface, but looped through COM or bi-directional LPT ports would also be possible. Here, the video and audio inputs and outputs are connected to the PC base box, as shown in FIG. 1. if the graphics card does not have a TV output, a VGA2PAL converter module is inserted into the PC base box and the VGA output is connected with the VGA cable of the PC base box. The monitor is connected to the converter's VGA output.

A suitable long AV extension cable is then laid between the room containing the PC and the room with the TV. One end is connected to the PC base box and the other end to the TV center box. The television is connected to this box (with a SCART cable) and the video recorder and the satellite receiver is connected to this.

Keyboard: a standard infrared webpad is divided as follows: the adapter box is connected as usual to the keyboard and mouse terminal. The battery-operated webpad itself is placed on a table in the room. With the webpad, the user can generate PC keyboard entries as follows: the webpad initially transmits IR frequencies coded in accordance with the keys. These IR frequencies are converted to cable signals (without decoding) and are a) reconverted to signals 1:1 at the PC and b) passed by the controller to the PC. The IR diode then transmits the signals into the room as IR signals. The standard receiver station of a webpad (linked to keyboard and mouse) is in the line of view. This generates the actual keyboard and mouse commands.

The infrared signals of the remote control that belongs to the solution presented here take the same signal path: IR transmitter of the remote control→IR receiver of the TV center box→cable signals→branching a) IR transmitter diode b) to the PC→in this case the signals are detected by the controller and forwarded to the PC→the remote control control commands are reinterpreted in keyboard commands for menu selection.

The signal path of the built-in microphone of the TV center box uses the TV audio output through a switch. Through this, the microphone uses the cable connection to the PC audio input. Standard software takes over voice recognition, menu controls through voice, or passes to telephony programs.

In principle, a camera could also be connected that is added to the video output cable of the television or of the video recorder. This would enable bi-directional video telephony. Mono-directional video telephony is already possible without an own camera.

A joystick would preferably be connected at the webpad. The control commands would be realized in the same way as the mouse commands of the integrated mouse in a standard webpad.

The appliance control in the room in which the TV is located is based on the one hand on the 12 V switching voltage. Through this, the PC forces the switchover to the AV channel and can therefore show “its” pictures. If the same program is running on the PC's TV card as on the television (and a previous program detection was possible for the PC program through reading out teletext at the TV input), the television viewer does not notice anything.

The television viewer then no longer sees the tuner output of his television set, video recorder or satellite receiver but the output of the TV card. However, the television viewer then has all the advantages of a TV card available: Mix mode with PC/Internet; inserting text, pictures in picture mode; multichannel preview (e.g. view 16 stations simultaneously on one screen); recording the program on a hard disk; saving images. In particular, EPGs are now used that are updated via the Internet and can support the user actively in selecting programs: independent channel changing through the PC software; masking unwanted program contents (commercials or child protection); recording on a video recorder or to a hard disk; inserting incoming mails or telephone calls; interactive television through overlaying menu interfaces with the TV picture; switchover at any time to the PC desktop and familiar control through mouse and keyboard, etc. In brief: computer-supported television without having to sit in front of a computer.

However, the arrangement that is introduced here not only enables this virtual channel, known as “personal TV”, to be played in, it can also control end appliances in the living room via infrared. The PC was taught the appropriate IR sequences through the learn diode of the PC base box and the sequences are saved to the hard disk. In addition, the sequence in which these signals must be transmitted to the end appliance is configured, for example, so that the television set switches to two-channel mode. Following this, the PC can control all appliances by transmitting the IR commands. The control is very secure in the case of the television, because the desired result of a channel change can be detected through the station callsign at the TV input (via the station ID in teletext).

Parental control requirements can also be realized in this way, because the PC can prevent unwanted stations being viewed, including, by means of EPG, program-related.

Extended examples of embodiments:

Television sets in other rooms can be integrated through a simple extension of the PC base box to several inputs and outputs. These can then access the video recorder, PC and other previously in accessible appliances (satellite receivers, etc.).

Example of an embodiment in a cable TV household:

Households that are connected to a broadband cable terminal have often already laid an antenna cable in a ring form from room to room in the house. The PC's TV card can now be connected to this cable.

Through the following change/variation of the PC base box and the TV center box the user saves the costs of laying a new AV cable.

The TV output is connected within the PC base box to an AV modulator. This supplies the outgoing TV signal (desktop, TV card/television programs, video playback from the hard disk or CD/DVD) into a free channel (e.g. video test channel 36). This channel, known as the “personal TV” channel, can now be received in the complete cable network, i.e. in the living room, bedroom and children's rooms. In most cases, egress to the house cable network is not wanted, so that a channel lock has to be set up here. The return channel from the television to the PC can, in principal, be carried out in the same way, optionally on the same channel or on another free channel. There are commercial IR extenders (conversion infrared→radio→infrared) available for the wireless transmission of infrared commands. A transmission link from the living room→study is sufficient here. If complete appliance control is wanted, an additional transmission link in the reverse direction is necessary.

A bi-directional DECT radio link is sufficient for the wireless transmission of the control command (switch control, 12 Volt generator, status queries). This also makes the infrared radio transmission obsolete and enables a low-cost uniform solution that, depending on the costs of the components, may even be lower than the cable solution.

1. Convergence boxes set for Personal Computers characterized by at least two appliances, whereby
one appliance is connected to the PC and the other directly to the television and an additional SCART appliance,
communication between the appliances takes place via cable or radio consisting of the audio-video transmission from and to the appliance at the television and additional control and infrared commands, whereby all programs on the PC and screen outputs are visible on the television via AV channel,
it is possible to control the PC from a position in front of the television with the familiar keyboard, mouse or remote control,
software on the PC operates audio-video switches that switch over the audio-video signals between the connected appliances in the switches installed at the television,
the audio-video input of the television is linked here alternately with the PC's audio-video output or with that of the additional appliance.

2. Convergence boxes set in accordance with claim 1, characterized by additional separating filters, whereby the audio-video output that leads to the PC's audio-video input is in addition linked alternately to the audio-video output of the television or of the additional appliance, and/or consisting in addition of a separating filter that links the video input of the additional appliance alternately to the PC's video output or that of the television.

3. Convergence boxes set in accordance with at least one of claims 1 and 2, characterized by an additional infrared transmitter at the appliance that is linked to the PC and an infrared receiver at the appliance that is linked to the television, and data forwarding between the infrared receiver and transmitter via cable or radio, which outputs the infrared frequencies received at the television in the PC environment, whereby standard infrared keyboards (with mouse or joystick terminal) an remote controls remain compatible and can be used.

4. Convergence boxes set in accordance with at least one of the claims 1 to 3, characterized by a signal splitter upstream from the infrared transmitters, whereby this splitter gives the signals to the data input of the PC that enables software installed on the PC to detect which button on the remote control was pressed.

5. Convergence boxes set in accordance with at least one of the claims 1 to 4, characterized by an additional microphone installed in the appliance at the television that is added to the television's audio output and can therefore use the audio link to the PC as well.

6. Convergence boxes set in accordance with at least one of the claims 1 to 5, characterized by an additional camera installed in the appliance at the television that is added to the television's video output (composite or S-VHS) and can therefore use the audio link to the PC as well.

7. Convergence boxes set in accordance with at least one of the claims 1 to 6, characterized by additional controllers planned on both sides of the cable transmission path that join multi-core bi-directional control cables into a two-core control cable and therefore enable the use of traditional standard SCART cables, and in addition containing a 12.5 Volt generator that can be activated vie PC software and that applies a switching voltage to the appropriate SCART pin 8 in the television.

8. Convergence boxes set in accordance with at least one of the claims 1 to 7, characterized by additional infrared transmitter diodes in the appliance part that is connected at the television by means of which the PC program transmits infrared remote control signals that were previously stored in the PC, whereby these signals control all infrared-controlled end appliances that are in the same room as the television, for example, satellite receivers, digital receivers, video recorders and the television itself, whereby the control signals are, for example, channel up, louder, lower, mute, channel down, numbers 1 to 9, etc., and the PC control can be informed of the actually selected channel through the video transmission channel from the television to the PC in that the station name is determined from the station's teletext.

9. Convergence boxes set in accordance with at least one of the claims 1 to 8, characterized by the fact that, instead of a cable or radio link, audio-video transmission takes place through feed-in into the house-hold's cable network through frequency modulators, whereby these modulators are installed on the one hand in the appliance part that is connected to the PC and on the other at that appliance part that is connected to the television, whereby the inputs of the latter modulators are connected alternately with the television's outputs and the video recorder's outputs and the inputs of the modulator at the PC are connected with the PC's audio-video outputs.

10. Convergence boxes set in accordance with at least one of the claims 1 to 9, characterized by the fact that, instead of the PC monitor images being fed into the AV channel the feed-in takes place into one of the cable channels and is received with standard cable tuners for the television or video recorder, whereby the audio-video transmission by the modulator of the appliance that is connected with the television is received in the PC through the TV card tuner.

11. Convergence boxes set in accordance with at least one of the claims 1 to 10, characterized by the fact that this can work together with several of the appliance parts that are connected at the television and that therefore additional audio-video transmission cable connections or audio-video radio transmitters are provided in the appliance part that is connected at the PC, or uses additional cable channels for transmitting and receiving audio-video signals, fitted in addition with separating filters in the appliance part that is connected at the PC that are controllable from the PC, whereby the controllers send and receive the commands referred to with a supplementary address that specifies the origin and the destination of the commands, so that the software installed on the PC permits some of the users (e.g. parents) of a networked system of this kind to look in other rooms (e.g. children's rooms) (if cameras are installed) or to ascertain which channels are being watched in this room (through station detections by means of teletext evaluation), whereby the requirements of parental control are realized in that the software at the PC detects whether programs unsuitable for children are being watched (by comparing with an EPG) and transmits appropriate infrared signals to force a change of channel.

12. Convergence boxes set in accordance with at least one of the claims 1 to 11, characterized by an additional infrared signal filter that makes the portable input appliances capable of use in the user's bedroom but if required ignores signals from the child's room.
